(19) United States
(12) Patent Application Publication
(10) Pub. No.: US 2017/0181094 A1
(43) Pub. Date: Jun. 22, 2017

(54) Intelligent terminal power consumption control method and electronic device

(71) Applicants: Le Holdings (Beijing) Co., Ltd., Beijing (CN); Lemobile Information Technology (Beijing) Co., Ltd., Beijing (CN)

(72) Inventor: Shufeng Ren, Beijing (CN)

(21) Appl. No.: 15/243,799

(22) Filed: Aug. 22, 2016

Related U.S. Application Data
(63) Continuation of application No. PCT/CN2016/088797, filed on Jul. 6, 2016.

(30) Foreign Application Priority Data
Dec. 18, 2015 (CN) 201510959085.0

(51) Int. Cl. H04W 52/02

(52) U.S. Cl. CPC H04W 52/0254; H04W 52/029

(57) ABSTRACT

The embodiments of the application disclose an intelligent terminal power consumption control method and an electronic device. The method includes: enabling a terminal to enter an early suspend state when a first preset operation is detected or no operation is detected within a preset time during a resume state of the terminal; and reducing CPU frequency when it is detected that the terminal is not being charged during the early suspend state of the terminal. Thus, the CPU frequency is reduced when an intelligent terminal enters the early suspend state, thereby reducing power consumption, prolonging standby time and enhancing user experience.

### CROSS REFERENCE TO RELATED APPLICATIONS

This application is a continuation of International Application No. PCT/CN2016/088797, filed on Jul. 6, 2016, which is based upon and claims priority to Chinese Patent Application No. 201510959085.0, filed on Dec. 18, 2015, titled “Intelligent Terminal Power Consumption Control Method and System”, the entire contents of which are incorporated herein by reference.

### TECHNICAL FIELD

The application relates to the technical field of power management, and particularly relates to an intelligent terminal power consumption control method and an electronic device.

### BACKGROUND

In the prior arts, power consumption is a major disadvantage of intelligent devices, such as intelligent mobile phones, etc., as well as a troublesome problem for most users of the intelligent mobile phones. How to increase the standby time of the mobile phones with limited battery capacity is a major job to study and is of great significance.

For example, a suspend resume mechanism of an Android system comprises an early suspend state, a suspend state, a late resume state and a resume state. In the existing solution, for various application scenarios in the early suspend state of the mobile phones, CPU frequency is not modulated and a dynamic frequency modulation strategy used in the resume state is still used generally, but the CPU is generally operating with high frequency at this moment, in this way, a waste of power consumption is caused in case that high frequency is not required.

### SUMMARY

The application provides an intelligent terminal power consumption control method and an electronic device, and solves the technical problem that the existing suspend resume mechanism of an intelligent terminal causes a waste of power consumption.

One objective of the embodiments of the application is to provide an intelligent terminal power consumption control method, comprising:

enabling a terminal to enter an early suspend state when a first preset operation is detected or no operation is detected within a preset time during a resume state of the terminal; and

reducing CPU frequency when it is detected that the terminal is not being charged during the early suspend state of the terminal.

Preferably, the method further comprises:

enabling the terminal to enter a late resume state and resuming the CPU frequency when a second preset operation is detected during the early suspend state of the terminal.

Preferably, the method further comprises:

when the first preset operation is detected or no operation is detected within the preset time, turning off a screen of the terminal.

Preferably, the first preset operation comprises pressing a power button or long-pressing a HOME button.

Preferably, the second preset operation comprises pressing the power button or double-clicking the screen.

Another objective of the embodiments of the application is to provide an intelligent terminal power consumption control electronic device, comprising: at least one processor; and a memory communicably connected with the at least one processor for storing instructions executable by the at least one processor, wherein execution of the instructions by the at least one processor causes the at least one processor to: enable a terminal to enter an early suspend state when a first preset operation is detected or no operation is detected within a preset time during a resume state of the terminal; and reduce CPU frequency when it is detected that the terminal is not being charged during the early suspend state of the terminal.

The electronic device, wherein, the at least one processor is further caused to enable the terminal to enter a late resume state and resume the CPU frequency when a second preset operation is detected during the early suspend state of the terminal.

The electronic device, wherein, when the first preset operation is detected or no operation is detected within the preset time, the at least one processor is further caused to turn off a screen of the terminal.

The electronic device, wherein, the first preset operation comprises pressing a power button or long-pressing a HOME button.

A further objective of the embodiments of the application is to provide a non-transitory computer-readable storage medium storing executable instructions that, when executed by an electronic device, cause the electronic device to: enable a terminal to enter an early suspend state when a first preset operation is detected or no operation is detected within a preset time during a resume state of the terminal; and reduce CPU frequency when it is detected that the terminal is not being charged during the early suspend state of the terminal.

In a class of embodiment, the electronic device is further caused to enable the terminal to enter a late resume state and resume the CPU frequency when a second preset operation is detected during the early suspend state of the terminal.

In a class of embodiment, when the first preset operation is detected or no operation is detected within the preset time, the electronic device is further caused to turn off a screen of the terminal.

The first preset operation comprises pressing a power button or long-pressing a HOME button.

The second preset operation comprises pressing the power button or double-clicking the screen.

In the intelligent terminal power consumption control method and electronic device of the embodiments of the application, CPU frequency is reduced when an intelligent terminal enters an early suspend state, thereby reducing power consumption, prolonging standby time and enhancing user experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an intelligent terminal power consumption control method in the embodiments of the application;

FIG. 2 is a schematic diagram of an intelligent terminal power consumption control electronic device in the embodiments of the application;

FIG. 3 is a schematic diagram of hardware configuration of an electronic device provided by the embodiments of the application.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

As shown in FIG. 1, the embodiments of the application provide an intelligent terminal power consumption control method, comprising:

step S1, enabling a terminal to enter an early suspend state when a first preset operation is detected or no operation is detected within a preset time during a resume state of the terminal;

wherein, the first preset operation depends on specific terminal settings, and can be, but not limited to a touch operation, a voice operation, etc.; the touch operation can comprise pressing a preset button or making a preset gesture, and the voice operation comprises receiving a voice command from a user by the system; the preset time can be set according to the need of the user; the shorter the time is, the better the reduction of the power consumption is, but inconvenience in operation may be caused; generally, the preset time can be set as 15 seconds, 30 seconds, 1 minute, etc.;

in addition, when the terminal is in the early suspend state, the operating system of the terminal can have at least one effective resume lock; the resume lock is a lock held by programs or services for preventing the programs or services from being disabled due to suspend; as long as the system has at least one resume lock, the system is prevented from entering the suspend state from the early suspend state; and at this moment, the programs or services holding the resume lock can be normally operated; specifically, the programs or services holding the resume lock comprise music playing, downloading, social programs, etc.; and

step S2, reducing CPU frequency when it is detected that the terminal is not being charged during the early suspend state of the terminal;

wherein, the CPU frequency before the reduction can be in a dynamic frequency modulation state, i.e., the frequency is dynamically modulated within a certain frequency range according to the system load, and the reduced CPU frequency should be lower than the minimum of the above frequency range; preferably, the CPU frequency is reduced to a fixed frequency value; the early suspend state is a state with low system load and it is not necessary to still implement the dynamic frequency modulation strategy, so the fixed frequency is preferred.

In the embodiment, the CPU frequency is reduced when the intelligent terminal enters the early suspend state, thereby reducing power consumption, prolonging standby time and enhancing user experience.

As a preferred embodiment, as shown in FIG. 1, the method can also comprise:

step S3, enabling the terminal to enter a late resume state and resuming the CPU frequency when a second preset operation is detected during the early suspend state of the terminal;

wherein, the second preset operation depends on specific terminal settings, and can be, but not limited to, a touch operation, a voice operation, etc.; the touch operation can comprise pressing a preset button or making a preset gesture, and the voice operation comprises receiving a voice command from a user by the system; and the second preset operation can be the same as or different from the first preset operation.

Preferably, the first preset operation comprises pressing a power button or long-pressing a HOME button.

Preferably, the second preset operation comprises pressing the power button or double-clicking the screen.

Preferably, when the first preset operation is detected or no operation is detected within the preset time, the method further comprises: turning off a screen of the terminal for reducing energy consumption.

### Embodiment 2

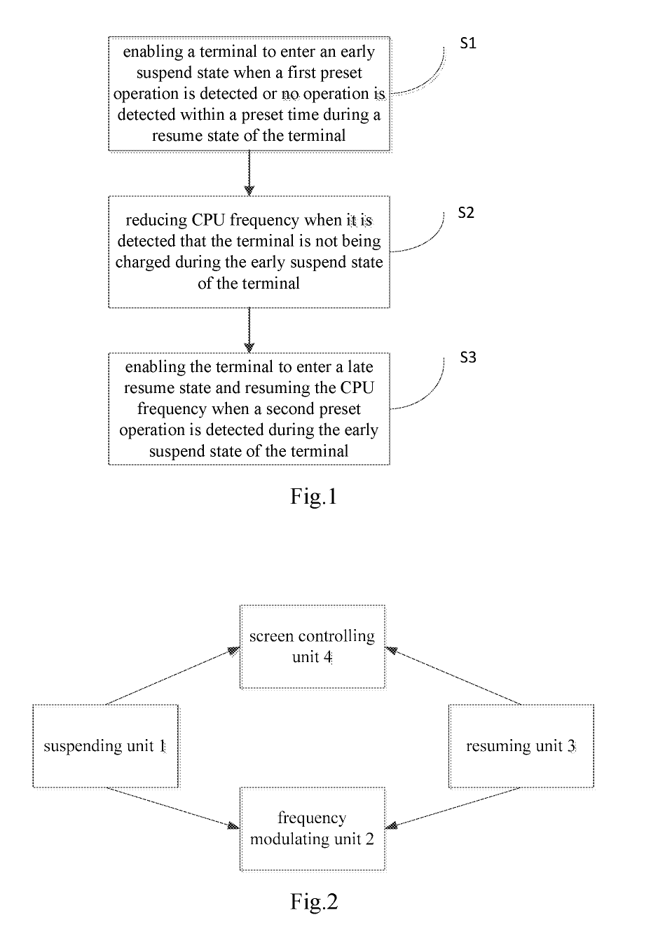

As shown in FIG. 2, the embodiments of the application also provide an intelligent terminal power consumption control system, comprising: a suspending unit 1 used for enabling a terminal to enter an early suspend state when a first preset operation is detected or no operation is detected within a preset time during a resume state of the terminal; and a frequency modulating unit 2 used for reducing CPU frequency when it is detected that the terminal is not being charged during the early suspend state of the terminal.

Preferably, as shown in FIG. 2, the system further comprises a resuming unit 3 used for enabling the terminal to enter a late resume state and resuming the CPU frequency when a second preset operation is detected during the early suspend state of the terminal.

Preferably, as shown in FIG. 2, the system further comprises a screen controlling unit 4 used for turning off a screen of the terminal when the first preset operation is detected or no operation is detected within the preset time.

Preferably, the first preset operation comprises pressing a power button or long-pressing a HOME button.

Preferably, the second preset operation comprises pressing the power button or double-clicking the screen.

To describe the technical effect of the application, Table 1 shown below further provides actual test results:

TABLE 1
Comparison of Influences of Frequency Modulation
for Listening to Music on Power Consumption

| | Power consumption | Power consumption |
|---|---|---|
| | of the system in the | of the system in the |
| | early suspend state | early suspend state |
| | without reducing the | while reducing the CPU |
| Times of | CPU frequency | frequency (unit: mA) |
| Test | (unit: mA) | Note: reducing to 403 MHz |
| 1 | 55.67 | 47.65 |
| 2 | 56.12 | 48.03 |
| 3 | 55.95 | 47.97 |
| 4 | 56.35 | 48.25 |
| 5 | 55.76 | 47.77 |
| Average | 55.97 | 47.93 |

It can be seen that the power consumption of the system can be reduced by 8 mA by reducing the CPU frequency in the early suspend state, thereby achieving the effect of power saving.

### Embodiment 3

The embodiments of the application provide a non-transitory computer-readable storage medium storing executable instructions that, when executed by an electronic device, cause the electronic device to: enable a terminal to enter an early suspend state when a first preset operation is detected or no operation is detected within a preset time during a resume state of the terminal; and reduce CPU frequency when it is detected that the terminal is not being charged during the early suspend state of the terminal.

As a preferred embodiment, the electronic device is further caused to enable the terminal to enter a late resume state and resume the CPU frequency when a second preset operation is detected during the early suspend state of the terminal.

As a preferred embodiment, when the first preset operation is detected or no operation is detected within the preset time, the electronic device is further caused to turn off a screen of the terminal.

As a preferred embodiment, the first preset operation comprises pressing a power button or long-pressing a HOME button.

As a preferred embodiment, the second preset operation comprises pressing the power button or double-clicking the screen.

### Embodiment 4

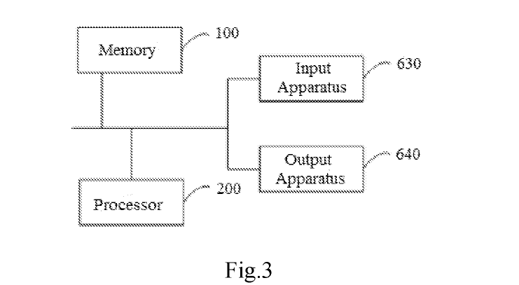

FIG. 3 is a schematic diagram of the hardware configuration of the electronic device provided by the embodiment, which performs the intelligent terminal power consumption control method. As shown in FIG. 3, the electronic device includes: one or more processors 200 and a memory 100, wherein one processor 200 is shown in FIG. 3 as an example. The electronic device that performs the intelligent terminal power consumption control method further includes an input apparatus 630 and an output apparatus 640.

The processor 200, the memory 100, the input apparatus 630 and the output apparatus 640 may be connected via a bus line or other means, wherein connection via a bus line is shown in FIG. 3 as an example.

The memory 100 is a non-transitory computer-readable storage medium that can be used to store non-transitory software programs, non-transitory computer-executable programs and modules, such as the program instructions/modules corresponding to the intelligent terminal power consumption control method of the embodiments of the application (e.g. suspending unit 1, frequency modulating unit 2, resuming unit 3, and screen controlling unit 4 shown in the FIG. 2). The processor 200 executes the non-transitory software programs, instructions and modules stored in the memory 100 so as to perform various function application and data processing of the server, thereby implementing the intelligent terminal power consumption control method of the above-mentioned method embodiments

The memory 100 includes a program storage area and a data storage area, wherein, the program storage area can store an operation system and application programs required for at least one function; the data storage area can store data generated by use of an intelligent terminal power consumption control device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the intelligent terminal power consumption control device via network connection. Examples of the aforementioned network include but not limited to internet, intranet, LAN, GSM, and their combinations.

The input apparatus 630 receives digit or character information, so as to generate signal input related to the user configuration and function control of the intelligent terminal power consumption control device. The output apparatus 640 includes display devices such as a display screen.

The one or more modules are stored in the memory 100 and, when executed by the one or more processors 200, perform the intelligent terminal power consumption control method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. An intelligent terminal power consumption control method, comprising:
enabling a terminal to enter an early suspend state when a first preset operation is detected or no operation is detected within a preset time during a resume state of the terminal; and
reducing CPU frequency when it is detected that the terminal is not being charged during the early suspend state of the terminal.

2. The method of claim 1, further comprising:
enabling the terminal to enter a late resume state and resuming the CPU frequency when a second preset operation is detected during the early suspend state of the terminal.

3. The method of claim 1, wherein, when the first preset operation is detected or no operation is detected within the preset time, further comprising: turning off a screen of the terminal.

4. The method of claim 1, wherein, the first preset operation comprises pressing a power button or long-pressing a HOME button.

5. The method of claim 1, wherein, the second preset operation comprises pressing the power button or double-clicking the screen.

6. An electronic device, comprising: at least one processor; and a memory communicably connected with the at least one processor for storing instructions executable by the at least one processor, wherein execution of the instructions by the at least one processor causes the at least one processor to:
enable a terminal to enter an early suspend state when a first preset operation is detected or no operation is detected within a preset time during a resume state of the terminal; and
reduce CPU frequency when it is detected that the terminal is not being charged during the early suspend state of the terminal.

7. The electronic device of claim 6, wherein, the at least one processor is further caused to enable the terminal to enter a late resume state and resume the CPU frequency when a second preset operation is detected during the early suspend state of the terminal.

8. The electronic device of claim 6, wherein, when the first preset operation is detected or no operation is detected within the preset time, the at least one processor is further caused to turn off a screen of the terminal.

9. The electronic device of claim 6, wherein, the first preset operation comprises pressing a power button or long-pressing a HOME button.

10. The electronic device of claim 6, wherein, the second preset operation comprises pressing the power button or double-clicking the screen.

11. A non-transitory computer-readable storage medium storing executable instructions that, when executed by an electronic device, cause the electronic device to:
enable a terminal to enter an early suspend state when a first preset operation is detected or no operation is detected within a preset time during a resume state of the terminal; and
reduce CPU frequency when it is detected that the terminal is not being charged during the early suspend state of the terminal.

12. The non-transitory computer-readable storage medium of claim 11, wherein, the electronic device is further caused to enable the terminal to enter a late resume state and resume the CPU frequency when a second preset operation is detected during the early suspend state of the terminal.

13. The non-transitory computer-readable storage medium of claim 11, wherein, when the first preset operation is detected or no operation is detected within the preset time, the electronic device is further caused to turn off a screen of the terminal.

14. The non-transitory computer-readable storage medium of claim 11, wherein, the first preset operation comprises pressing a power button or long-pressing a HOME button.

15. The non-transitory computer-readable storage medium of claim 11, wherein, the second preset operation comprises pressing the power button or double-clicking the screen.
